(19) United States
(12) Patent Application Publication
(10) Pub. No.: US 2016/0127695 A1
(43) Pub. Date: May 5, 2016

(54) METHOD AND APPARATUS FOR CONTROLLING A CAMERA'S FIELD OF VIEW

(71) Applicant: MOTOROLA SOLUTIONS, INC, SCHAUMBURG, IL (US)

(72) Inventors: YAN ZHANG, BUFFALO GROVE, IL (US); KENNETH W. DOUROS, SOUTH BARRINGTON, IL (US); PATRICK D. KOSKAN, LAKE WORTH, FL (US)

(21) Appl. No.: 14/528,333

(22) Filed: Oct. 30, 2014

(51) Int. Cl. H04N 7/18; H04N 5/232

(52) U.S. Cl. CPC H04N 7/183; H04N 5/23296

(57) ABSTRACT

A method and apparatus for controlling a camera's field of view is provided herein. During operation equipment will receive a location of at least one user device. The equipment will also receive a location of a camera along with camera parameters. The equipment will determine a camera pan, tilt, and/or zoom level in order to increase a number of devices within a camera field of view.

### FIELD OF THE INVENTION

The present invention generally relates to controlling a camera's field of view, and more particularly, to controlling a camera's field of view based on a number of officers at an incident scene.

### BACKGROUND OF THE INVENTION

In many public-safety scenarios it is desirable for public-safety officers to be within a field of view of a camera recording an incident. (i.e., visible to the camera). For example, recorded video is often critical for event analysis and is acceptable evidence in many courts of law. Therefore, it would be beneficial to increase a probability that public-safety officers (e.g., police officers, firemen, paramedics, border patrol agents, . . . , etc.) on scene are within a field of view of a camera.

### BRIEF DESCRIPTION OF THE SEVERAL VIEWS OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 illustrates a general operational environment for a public-safety officer.

FIG. 2 illustrates a camera's field of view.

FIG. 3 is a block diagram of the server of FIG. 1.

FIG. 4 is a block diagram of a camera of FIG. 1.

FIG. 5 is a flow chart of the server of FIG. 3.

FIG. 6 is a flow chart of the camera of FIG. 4.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required.

### DETAILED DESCRIPTION

In order to address the above, mentioned need, a method and apparatus for controlling a camera's field of view is provided herein. During operation equipment will receive a location of at least one user device. The equipment will also receive a location of a camera along with camera parameters. The equipment will determine a camera pan, tilt, and/or zoom level in order to increase a number of devices within a camera field of view.

In a first embodiment, a server will receive the location of the user devices, the location of the camera, and the camera parameters. The server will then calculate optimal pan, tilt, zoom (PTZ) settings and send a PTZ control message to the camera. In a second embodiment, a camera will determine its location and camera parameters. The camera will receive the location of the user devices and control its own PTZ accordingly.

In one embodiment, a field of view is obtained via automated manipulation of PTZ motors attached to the camera. In an alternate embodiment of the present invention, the selected field of view is obtained via digital manipulation of a captured fixed field of view. In such embodiments, the camera is typically configured with a high resolution, wide angle lens and a high definition sensor. The camera then applies post processing techniques to digitally pan, tilt, and zoom a dynamically selected, narrow field of view (also known as a region of interest) within the fixed, captured, wide angle field of view.

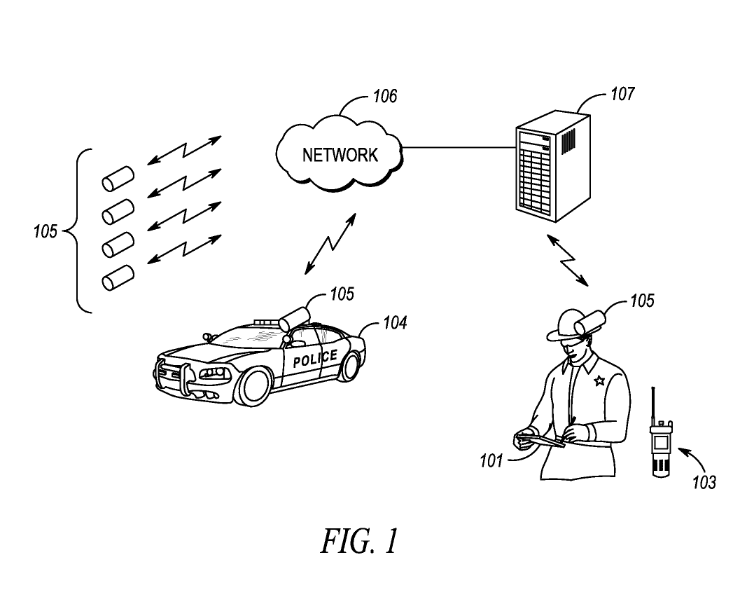

Turning now to the drawings wherein like numerals designate like components, FIG. 1 illustrates a general operational environment for a public-safety officer. As shown in FIG. 1, multiple cameras 105 are providing a live video feed and/or still images of objects within their Field Of View (FOV). Cameras 105 may be embodied in various physical system elements, including a standalone device, or as functionality in a Network Video Recording device (NVR), a Physical Security Information Management (PSIM) device, a camera bundled within a smart phone device, a camera worn by officer 101, a camera mounted on a public-safety vehicle 104, etc. Furthermore, the cameras 105 could be mounted on any mobile entity such as a vehicle 104 (terrestrial, aerial or marine) or mobile user 101 (such as a camera mounted on a user's helmet or lapel) or a mobile robot.

Public-safety officers 101 (only one shown) are usually associated with radios (devices) 103 such that the location of device 103 is usually indicative of the location of the public-safety officer. Device 103 can be any portable electronic device that is associated with a particular officer, including but not limited to a standalone display or monitor, a handheld computer, a tablet computer, a mobile phone, a police radio, a media player, a personal digital assistant (PDA), a GPS receiver, or the like, including a combination of two or more of these items. Devices 103 are equipped with circuitry (not shown) such as a GPS receiver that is utilized to determine its location. This location can be transmitted to other system components.

During operation, cameras 105 continuously capture a real-time video stream. Along with the video steam, cameras 105 may also capture camera parameters that includes the geographic location of a particular camera 105 (e.g., GPS coordinates) and an “absolute direction” (such as N, W, E, S) associated with each video stream, and an optional tilt (e.g., 25 degrees from level). Additional camera parameters such as a camera resolution, focal length, type of camera, and/or time of the day may be captured.

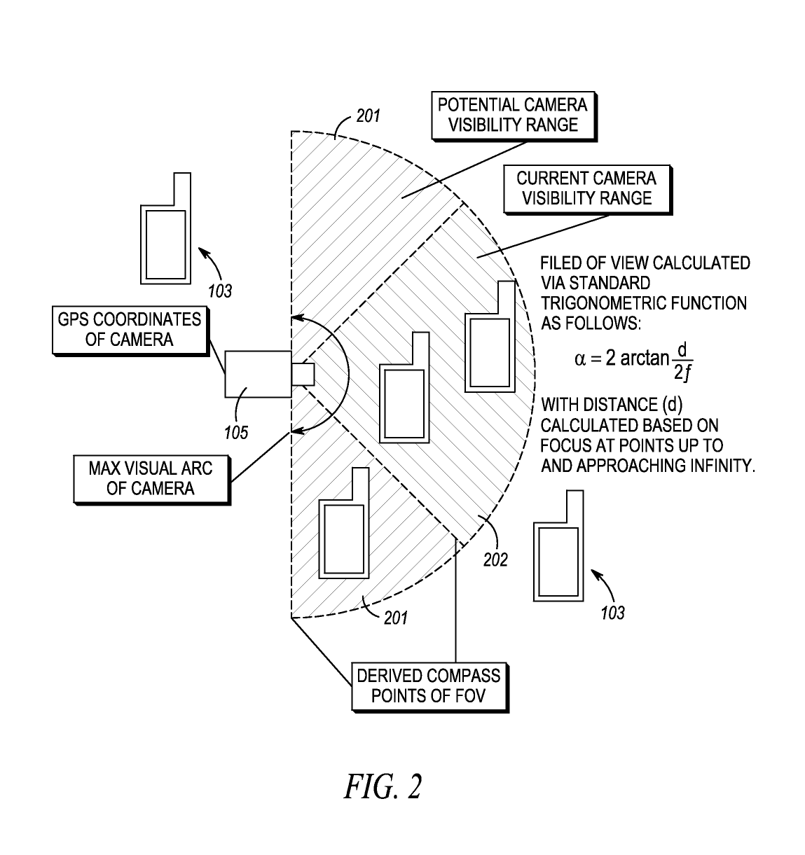

It should be noted that the direction of the camera refers to the direction of the camera's field of view in which camera 105 is recording. Thus, the camera parameters may provide information such as, but not limited to the fact that camera 105 is located at a particular location and pointing in a particular direction, with a particular focal length. The FOV may be identified from the camera parameters as shown in FIG. 2.

The camera parameters as described above can be collected from a variety of sensors (not shown) such as location sensors (such as via Global Positioning System (GPS)), gyroscopes, compasses, and/or accelerometers associated with the camera. The camera parameters may also be indirectly derived from a Pan-Tilt-Zoom functionality of the camera. Furthermore, the aforementioned sensors may either be directly associated with the camera or associated with the mobile entity with which the camera is coupled such as a smart phone, the mobile user, a vehicle, or a robot.

In the first embodiment, the camera parameters are transmitted from the camera to server 107 so that server 107 may calculate an appropriate PTZ for the camera. In the second embodiment the camera parameters are used by camera 105 so that camera 105 may calculate an appropriate PTZ for itself.

As can be readily understood by those skilled in the art, the transmission of video and the supporting camera parameters may traverse one or more communication networks 106 such as one or more of wired and/or wireless networks. Furthermore, the video and camera parameters may first be transmitted to server 107 which may post-process the video feed and then transmit the feed to one or more devices 103. Note that server 107 may record and keep a copy of the video feed for future use for example to transmit the recorded video and camera parameters to an investigator for investigative purposes at a later time.

As described above, the camera parameters may comprise a current location of a camera 105 (e.g., 42 deg 04′ 03.482343″ lat., 88 deg 03′ 10.443453″ long. 727 feet above sea level), and a compass direction to which the camera is pointing (e,g, 270 deg. from north), and a level direction of the camera (e.g., −25 deg. from level) and a zoom level (e.g., 5×). This information can then be passed to server 107 so that the camera's location, direction, and level can be used to determine the camera's field of view. As mentioned above, in an alternate embodiment, the camera may determine its own field of view from the camera parameters.

In some embodiments, such as when the camera has a pan-tilt-zoom (PTZ) schedule, or is coupled with a mobile entity such as a mobile user, a vehicle, or a robot, the camera parameters are expected to change during the course of the video feed. Therefore, as the camera moves, or captures a different field of view, the camera parameters will need to be updated accordingly. Thus, at a first time, server 107 may be receiving first camera parameters from a camera 105, and at a second time, server 107 may be receiving second (differing) camera parameters from the camera 105.

Each device 103 is associated with context-aware circuitry (compass, gyroscope, accelerometers, location finding equipment, and other sensors) used to determine a location. This information may also be provided to server 107. Server 107 may forward this information to camera 105. Thus, camera 105 and/or server 107 may “know” the field of view of camera 105 and the location of devices 103. Based with this knowledge, server 107 (first embodiment) and/or camera 105 (second embodiment) may calculate an appropriate PTZ setting.

An appropriate PTZ setting for camera 105 may be determined to best capture any devices 103 at a particular scene. The camera's PTZ may be adjusted accordingly. For example, if a single officer is slightly north of a camera's field of view, the camera may be panned northward so that the officer is brought into the field of view. Similarly, if multiple devices 103 are on scene, the camera's zoom may be decreased to increase the probability that all officers on scene are within the camera's field of view. For example, assume that three officers are within a camera's field of view, and that a fourth officer is slightly outside the field of view. A zoom level of the camera may be decreased so that all officers will be placed within the camera's field of view.

FIG. 2 illustrates a camera's field of view as it relates to devices 103. As shown in FIG. 2, as devices 103 are scattered about an incident scene, they may or may not be within a field of view 202 of a particular camera 105. Thus, when devices 103 are outside area 202, they are not visible by camera 105. A camera is capable of modifying a PTZ setting to potentially view and device within areas 201 and 202 (not simultaneously). Areas 201 and 202 may grow or shrink based upon a camera's zoom level. Areas 201 and 202 may also change direction based on a camera's pan and tilt direction. As discussed, areas 201 and 202 will be manipulated to increase a probability that all devices 103 are within a cameras field of view (i.e., within areas 201 and/or 202).

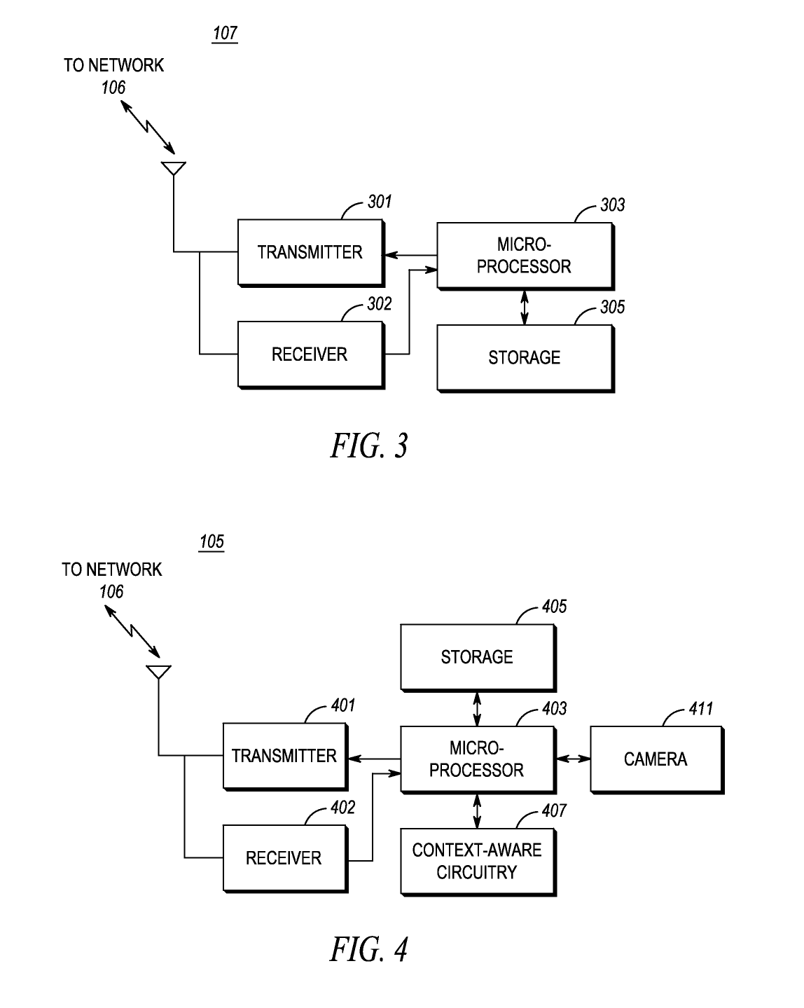

FIG. 3 is a block diagram of the server of FIG. 1. Server 107 typically comprises processor or microprocessor controller 303 that is communicatively coupled with various system components, including transmitter 301, receiver 302, and general storage component 305. Only a limited number of system elements are shown for ease of illustration; but additional such elements may be included in the server 107.

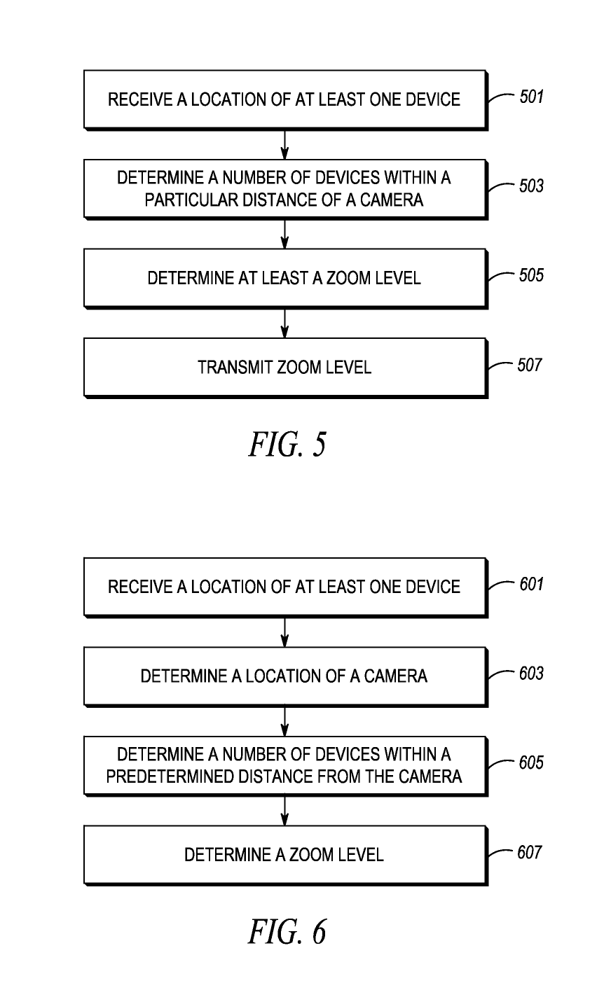

Processing device 303 may be partially implemented in hardware and, thereby, programmed with software or firmware logic or code for performing functionality described in FIG. 5. The processing device 303 may be completely implemented in hardware, for example, as a state machine or ASIC (application specific integrated circuit).

Storage 305 can include short-term and/or long-term storage (e.g., RAM, and/or ROM) and serves to store various information needed to determine whether or not a device is within a field of view of a camera (i.e., visible to the camera) and determine a PTZ setting to increase a probability that all devices at a particular incident scene are within a camera's FOV. Storage 305 may further store software or firmware for programming the processing device 303 with the logic or code needed to perform its functionality.

Transmitter 301 and receiver 302 are common circuitry known in the art for communication utilizing a well known communication protocol, and serve as means for transmitting and receiving messages. For example, receiver 302 and transmitter 301 may be well known long-range transceivers that utilize the Apco 25 (Project 25) communication system protocol. Other possible transmitters and receivers include, IEEE 802.11 communication system protocol, transceivers utilizing Bluetooth, HyperLAN protocols, or any other communication system protocol. Server 107 may contain multiple transmitters and receivers, to support multiple communications protocols.

In the first embodiment processor 303 receives camera parameters from a camera 105. This information may be received by receiver 302 or may have been received by other means (e.g., pre-populated) and stored in storage 305. Processor 303 also receives a current location of at least one user device 103. Again, this information may be received via receiver 302 receiving transmissions from device 103. Based on this information, processor 303 calculates a PTZ setting needed to bring as many devices 103 into the FOV as possible. This information is provided to transmitter 301 and transmitted to device 103 through intervening network 106.

Thus an embodiment where server 107 is calculating optimal PTZ settings, receiver 302 receives from camera 105 one or more of, a geographic location of a camera, a level setting in which a camera is pointing, and a compass direction in which a camera is pointing. From this information, processor 303 can calculate a FOV of camera. For example, based on the geographic location, level, and compass heading, a FOV of a camera can be determined by microprocessor 403. For example, a current location of the camera may be determined (e.g., 42 deg 04′ 03.482343″ lat., 88 deg 03′ 10.443453″ long. 727 feet above sea level), and a compass bearing matching the camera's pointing direction may be determined (e,g, 270 deg. from North), a level direction of the camera may be determined (e.g., −25 deg. from level). From the above information, the camera's FOV is determined by determining a geographic area captured by the camera having objects above a certain dimension resolved. For example a FOV may comprise any two or three-dimensional geometric shape that has, for example, objects greater than 1 cm resolved (occupying more than 1 pixel).

When receiver 302 receives a location for devices 103, microprocessor 303 may then calculate whether or not devices 103 are within a current FOV of the camera. Microprocessor 403 can then calculate optimal PTZ settings for the camera so that as many devices 103 as possible are within camera's FOV. The camera will be instructed to change its PTZ settings accordingly by sending the camera appropriate PTZ settings via transmitter 301.

FIG. 4 is a block diagram of a camera of FIG. 1. Camera 105 typically comprises processor 403 that is communicatively coupled with various system components, including transmitter 401, receiver 402, general storage component 405, context-aware circuitry 407, and image capture device (e.g., CCD or camera) 411. Only a limited number of system elements are shown for ease of illustration; but additional elements may be included in camera 105.

Processing device 403 may be partially implemented in hardware and, thereby, programmed with software or firmware logic or code for performing functionality described in FIG. 6. The processing device 403 may be completely implemented in hardware, for example, as a state machine or ASIC (application specific integrated circuit). Storage 405 can include short-term and/or long-term storage of various information needed for determining whether or not device 103 is within a field of view of a camera. Storage 405 may further store software or firmware for programming the processing device 403 with the logic or code needed to perform its functionality.

Context-aware circuitry 407 preferably comprises a GPS receiver, a compass that identifies a location and direction of device 103, and an optional level sensor. For example, circuitry 407 may determine that device 103 is located at a particular latitude and longitude, and pointing North at 25 degrees below level.

Transmitter 401 and receiver 402 are common circuitry known in the art for communication utilizing a well known communication protocol, and serve as means for transmitting and receiving messages. For example, receiver 402 and transmitter 401 may be well known long-range transceivers that utilize the Apco 25 (Project 25) communication system protocol. Other possible transmitters and receivers include, IEEE 802.11 communication system protocol, transceivers utilizing Bluetooth, HyperLAN protocols, or any other communication system protocol. User device 103 may contain multiple transmitters and receivers, to support multiple communications protocols.

Camera 411 comprises a standard image/video capture device as discussed above, and is preferably capable of changing its PTZ settings in order to change its FOV.

In an embodiment where server 107 calculates whether or not device 103 is visible to any camera, camera 105 will use transmitter 401 to transmit location and PTZ information to server 107. In response, receiver 402 will receive information from server 107 that indicates an optimal PTZ setting best suited to capture devices 103 on scene.

In an embodiment where camera 105 is calculating optimal PTZ settings, context-aware circuitry 407 will provide processor 403 a geographic location, a level setting, and a compass direction. Camera 411 will provide camera parameters such as a zoom level to processor 403. Pan and tilt parameters may also be provided as an offset from level and compass direction. From this information, processor 403 can calculate a FOV of camera 411. For example, based on the geographic location, level, and compass heading, a FOV of a camera can be determined by microprocessor 403. For example, a current location of a camera may be determined (e.g., 42 deg 04′ 03.482343″ lat., 88 deg 03′ 10.443453″ long. 727 feet above sea level), and a compass bearing matching the camera's pointing direction may be determined (e,g, 270 deg. from North), a level direction of the camera may be determined (e.g., −25 deg. from level). From the above information, the camera's FOV is determined by determining a geographic area captured by the camera having objects above a certain dimension resolved. For example a FOV may comprise any two or three-dimensional geometric shape (e.g. a cone) that has, for example, objects greater than 1 cm resolved (occupying more than 1 pixel).

When receiver 402 receives a location for devices 103, microprocessor 403 may then calculate an optimal PTZ settings for camera 411 to increase the probability of devices 103 being within camera 411's FOV. Camera 411 will be instructed to change its PTZ settings accordingly.

### Determining an Appropriate PTZ Setting

In its simplest implementation, a camera will have its zoom setting adjusted based on a number of officers within a predetermined distance from the camera. For example, a first zoom setting (e.g., zoom 100%) may be utilized if a single officer is on scene (e.g., within a predetermined distance (e.g., ½ mile from the camera)). A second zoom setting may be utilized (e.g., zoom 50%) if a second officer is on scene. A third zoom setting (0% zoom) may be utilized if more than two officers are on scene. Thus, in this embodiment, equipment will determine a number of officers on scene and adjust the zoom based on the number of officers on scene.

In an alternate embodiment of the present invention, a PTZ setting will be chosen based on a number of officers on scene. The camera sensor and lens parameters needed for the camera, and obtained from circuitry 407, include:
image resolution,
focal length,
magnification and/or zoom setting of the lens,
location GPS coordinates,
heading,
tilt,
rotational range of the camera, expressed as compass points on a circle and
altitude of the camera above the surrounding ground.

A first technique for determining a PTZ setting comprises an empirical trigonometric step that extrapolates edge-to edge viewing limits based on the above camera lens parameters to determine whether or not each device is within a field of view. For example, the angle (α) between 2 vectors (u,v) in a plane can be determined by the equation cos α=((u1*v1)+(u2*v2))/(SQRT(u1̂2+u2̂2)*SQRT(v1̂2+v2̂2)). This angle describes the minimum viewing angle of the camera lens needed if aimed at the midpoint between the 2 vectors. Those skilled in the art will recognize similar linear algebra equations can be used to find the angle and midpoint for 3 or more vectors in free space. Based upon knowledge of the camera lens and location properties, the PTZ can be set to place the officers at the very edge of the viewing window or backed out 5 degrees for example to allow for movement. A comparison of various fields of view for all possible PTZ settings are used to determine if/where the officers should be present in the field of view. A PTZ setting is chosen that maximizes resolved devices within a field of view.

A brute force technique can find each officer's vector location from the camera based on location point to point camera rotation calculations and determine a maximum angle between officers. This technique starts with aiming camera at officer1 and then rotating camera as many degrees needed to aim directly at officer2. Using simple math, the system can determine the total degrees of rotation needed to go from officer1 to officer2, and then determine if the total degrees rotated is less than the camera lens' FOV at Zoom level 0. If it is less, then the camera can be rotated back to ½ the total degrees rotated and both subjects will be in the video frame. The system then can increase the zoom level as appropriate based on look-up tables entries determined from the camera properties so that the new FOV is just greater than needed to ensure both subjects are in frame and resolution is maximized. Video analytic technique may also be applied to verify persons within the captured video frame, but is not the basis for selecting PTZ levels. Based on the locations of the detected persons in the video frame along with known camera parameters, the FOV can be reduced and the camera zoom can be adjusted accordingly so that the furthest officers are at the edge of the adjusted FOV.

FIG. 5 is a flow chart of the server of FIG. 3. The logic flow begins at step 501 where receiver 302 receives a location of at least one device 103 and camera 105. (As discussed above, the location of the camera may not be received by receiver 302, but known and stored). At step 503 logic circuitry 303 determines a number of devices within a particular distance of a camera and determines at least a zoom level based on a number of devices within the particular distance (e.g., 500 m) of the camera (step 505). Finally, at step 507 transmitter 301 transmits at least the zoom level to camera 105.

As discussed, logic circuitry 303 may further determine a pan, tilt, and the zoom level of the camera to maximize a number of devices within a field of view of the camera. Additionally, the zoom level is a linear function of the number of devices within the particular distance from the camera, where zoom level=F(number of devices), where F is a linear function.

FIG. 6 is a flow chart showing operation of camera 105 in accordance with an embodiment of the present invention. The logic flow begins at step 601 where receiver 402 receives a location of at least one device 103. At step 603 location finding equipment 407 determines a location of a camera 105. The logic flow continues to step 605 where logic circuitry 403 determines a number of devices within a particular distance of a camera and at least a zoom level based on a number of devices within the particular distance from the camera (607). Finally, at step 609 camera 411 adjusts a zoom to the determined zoom level.

As discussed above, the logic circuitry may additionally determine a pan, tilt, and the zoom level of the camera to maximize a number of devices within a field of view of the camera. Additionally, the zoom level may be a linear function of the number of devices within the particular distance from the camera.

In the foregoing specification, specific embodiments have been described. However, one of ordinary skill in the art appreciates that various modifications and changes can be made without departing from the scope of the invention as set forth in the claims below. For example, a user of device 103 may be notified about camera visibility by integrating the above technique with audio, vibration, and/or a light indicator on device 103. Additionally, if a location of obstructing devices (e.g., large trucks) are known, these may be taken into consideration when calculating whether or not a device is visible to a camera. Additionally, in situations where a pan/tilt/zoom schedule is being utilized by a camera, schedule information may be provided as camera parameters and used as described above to notify a user when (i.e., what future time) they will be within the camera field of view. In addition, weather conditions may be obtained via any on-line web site and used to determine whether or not the device is within a camera field of view. For example, if hard rain or fog is identified at a particular camera site, it may be factored into whether or not the device is within the field of view. For example, the distance from the camera identified as being within the field of view may be decreased when rain or fog is detected. Accordingly, the specification and figures are to be regarded in an illustrative rather than a restrictive sense, and all such modifications are intended to be included within the scope of present teachings.

Those skilled in the art will further recognize that references to specific implementation embodiments such as “circuitry” may equally be accomplished via either on general purpose computing apparatus (e.g., CPU) or specialized processing apparatus (e.g., DSP) executing software instructions stored in non-transitory computer-readable memory. It will also be understood that the terms and expressions used herein have the ordinary technical meaning as is accorded to such terms and expressions by persons skilled in the technical field as set forth above except where different specific meanings have otherwise been set forth herein.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for calculating a zoom setting for a camera, the method comprising the steps of:
determining a location of a camera;
determining a location for at least one device;
determining a number of devices within a particular distance from the camera;
determining at least a zoom level based on a number of devices within the particular distance from the camera.

2. The method of claim 1 further comprising the step of:
determining a pan, tilt, and the zoom level of the camera to maximize a number of devices within a field of view of the camera.

3. The method of claim 1 wherein the steps of determining comprise the steps of determining within a server, and further comprising the step of:
transmitting the zoom level to the camera.

4. The method of claim 1 further comprising the step of:
adjusting the zoom of the camera based on the determined zoom level.

5. The method of claim 1 wherein the step of determining the zoom level comprises the step of determining the zoom level as a linear function of the number of devices within the particular distance from the camera.

6. A server comprising:
a receiver receiving a location of at least one device;
logic circuitry determining a number of devices within a particular distance of a camera and determining at least a zoom level based on a number of devices within the particular distance from the camera; and
a transmitter, transmitting the zoom level to the camera.

7. The server of claim 6 wherein the receiver additionally receives a location of the camera.

8. The server of claim 6 wherein the logic circuitry further determines a pan, tilt, and the zoom level of the camera to maximize a number of devices within a field of view of the camera.

9. The server of claim 6 wherein the zoom level is a linear function of the number of devices within the particular distance from the camera.

10. An apparatus comprising:
a receiver receiving a location of at least one device;
location finding equipment determining a location of a camera;
logic circuitry determining a number of devices within a particular distance of a camera and determining at least a zoom level based on a number of devices within the particular distance from the camera; and
a camera adjusting a zoom to the determined zoom level.

11. The camera of claim 10 wherein the logic circuitry further determines a pan, tilt, and the zoom level of the camera to maximize a number of devices within a field of view of the camera.

12. The camera of claim 10 wherein the zoom level is a linear function of the number of devices within the particular distance from the camera.
